(19) United States
(12) Patent Application Publication
(10) Pub. No.: US 2021/0078759 A1
(43) Pub. Date: Mar. 18, 2021

(54) BLANK OF A CUP AND A STRAW

(71) Applicants: Lauren Barnes, Colorado Springs, CO (US); Katherine Migaki, Denver, CO (US)

(72) Inventors: Lauren Barnes, Colorado Springs, CO (US); Katherine Migaki, Denver, CO (US)

(21) Appl. No.: 17/021,622

(22) Filed: Sep. 15, 2020

Related U.S. Application Data
(60) Provisional application No. 62/901,096, filed on Sep. 16, 2019.

(51) Int. Cl. B65D 5/44; B65D 5/40; B65D 5/64; B65D 5/42; B65D 65/46; B65D 65/42; B31B 50/84; B31B 50/00

(52) U.S. Cl. CPC B65D 5/44; B65D 5/40; B65D 5/64; B65D 5/4266; B31B 50/0045; B65D 65/42; B31B 50/84; B31B 50/0044; B65D 65/466

(57) ABSTRACT

A cup, a blank for a cup, and a method for forming a cup. As an example, a cup includes a base having a circular bottom and a rim coupled to a perimeter of the bottom; a sidewall extending upwards from the base between an upper edge and a lower edge, the sidewall being continuously coupled to the rim at the lower edge; a plurality of closure panels integrally connected to and extending from the sidewall at the upper edge, the plurality of closure panels includes a first closure panel having a first cutout and a second closure panel having a second cutout; a straw connected to and extending from a second end of the sidewall and extending upwards from near the lower edge to beyond the upper edge; and a tab connected to and extending from a first end of the sidewall and attaching the first end of the sidewall to a second end of the sidewall.

### CROSS-REFERENCES TO RELATED APPLICATIONS

This application claims priority to U.S. Patent Application No. 62/901,096 filed Sep. 16, 2019, which is incorporated by reference herein for all purposes.

### BACKGROUND

Conventional soft-drink cups include a paper cup and a plastic lid configured to be press-fit together. The plastic lid may include an opening, typically positioned centrally, for receiving a plastic straw. As described, conventional soft-drink cups include multiple separate pieces that may require different disposal methods. It is therefore desirable to have a cup with all its components comprising a single material and thus requiring only one disposal method. For example, a cup that is entirely compostable is desirable.

### BRIEF SUMMARY

In various embodiments, a cup includes a base having a circular bottom and a rim coupled to a perimeter of the bottom; a sidewall extending upwards from the base between an upper edge and a lower edge, the sidewall being continuously coupled to the rim at the lower edge; a plurality of closure panels integrally connected to and extending from the sidewall at the upper edge, the plurality of closure panels includes a first closure panel having a first cutout and a second closure panel having a second cutout; a straw connected to and extending from a second end of the sidewall and extending upwards from near the lower edge to beyond the upper edge; and a tab connected to and extending from a first end of the sidewall and attaching the first end of the sidewall to a second end of the sidewall. In certain examples, the plurality of closure panels is configured to be foldable between a closed position and an open position. In certain examples, when the plurality of closure panels is in the closed position: the first cutout and the second cutout overlap to define a straw receptacle configured to receive the straw, and the straw extends through the straw receptacle. In certain examples, the sidewall has a plurality of side fold lines connected to and extending from the upper edge towards the lower edge. In certain examples, the sidewall and the base define a content-receiving volume. In certain examples, the cup is biodegradable.

In some embodiments, the plurality of side fold lines extends from the upper edge towards the lower edge by at least 5% of the height of the cup.

In some embodiments, the plurality of side fold lines extends from the upper edge towards the lower edge by at most 20% of the height of the cup.

In some embodiments, the plurality of side fold lines is uniformly distributed about the content-receiving volume.

In some embodiments, the plurality of side fold lines includes five side fold lines.

In some embodiments, the plurality of closure panels includes a number of closure panels and the plurality of side fold lines includes a number of side fold lines, the number of closure panels equals to the number of side fold lines minus one.

In some embodiments, each closure panel of the plurality of closure panels is a segment of a circle.

In some embodiments, each closure panel of the plurality of closure panels is a semicircle.

In some embodiments, the cup is larger in size at the upper edge than at the lower edge.

In some embodiments, the straw receptacle is positioned at a first corner of a plurality of corners defined by the plurality of side fold lines at the upper edge.

In some embodiments, the straw has a triangular cross-section at least at the upper edge.

In some embodiments, the straw has a right-triangular cross-section at least at the upper edge.

In some embodiments, the plurality of closure panels integrally extends from a plurality of top fold lines.

In some embodiments, the cup comprises paper coated with a liquid-repelling coating.

In some embodiments, the liquid-repelling coating is bio-based polybutylene succinate.

In various embodiments, a blank for a cup includes: a sidewall extending between an upper edge and a lower edge; a plurality of closure panels integrally connected to and extending from the sidewall at the upper edge, the plurality of closure panels includes a first closure panel having a first cutout and a second closure panel having a second cutout; a plurality of straw panels connected to and extending from the sidewall from a second end of the sidewall, the plurality of straw panels configured to form a straw connected to and extending from the second end of the sidewall; and a tab connected to and extending from a first end of the sidewall and configured to attach the first end of the sidewall to the second end of the sidewall during cup assembly. In certain examples, the plurality of closure panels is configured to be foldable between a closed position and an open position. In certain examples, when the plurality of closure panels is in the closed position: the first cutout and the second cutout overlap to define a straw receptacle configured to receive the straw, and the straw extends through the straw receptacle. In certain examples, the sidewall has a plurality of side fold lines connected to and extending from the upper edge towards the lower edge. In certain examples, the blank is biodegradable.

In some embodiments, the plurality of side fold lines extends from the upper edge towards the lower edge by at least 5% of the height of the cup.

In some embodiments, the plurality of side fold lines extends from the upper edge towards the lower edge by at most 20% of the height of the cup.

In some embodiments, each closure panel of the plurality of closure panels is a segment of a circle.

In various embodiments, a method for forming a cup from a blank includes: rolling a plurality of straw panels of the blank into a straw having a triangular cross-section and connected to and extending from an upper edge of the cup towards a lower edge of the cup by at least 80% of the height of the cup; folding a sidewall of the blank along a plurality of side fold lines of the sidewall; rolling the sidewall to couple a base to the sidewall at the lower edge to define a content-receiving volume; and attaching a first end of the sidewall with a second end of the sidewall by affixing a tab connected to and extending from the first end of the sidewall to the second end of the sidewall. In certain examples, rolling the sidewall includes positioning the straw at a corner along a side fold line of the plurality of side fold lines of the sidewall.

Depending upon embodiment, one or more benefits may be achieved. These benefits and various additional objects, features and advantages of the subject matter provided by the present disclosure can be fully appreciated with reference to the detailed description and accompanying drawings that follow.

### BRIEF DESCRIPTION OF THE DRAWINGS

FIG. 1 is a simplified diagram showing a cup, according to some embodiments.

FIG. 2 is a simplified diagram showing a blank, according to some embodiments.

FIG. 3 is a simplified diagram showing a plurality of straw panels rolled into a straw, according to some embodiments.

FIG. 4 is a simplified diagram showing a sidewall in an unrolled state, according to some embodiments.

FIG. 5 is a simplified diagram showing a sidewall in the process of transitioning between an unrolled state and a rolled state, according to some embodiments.

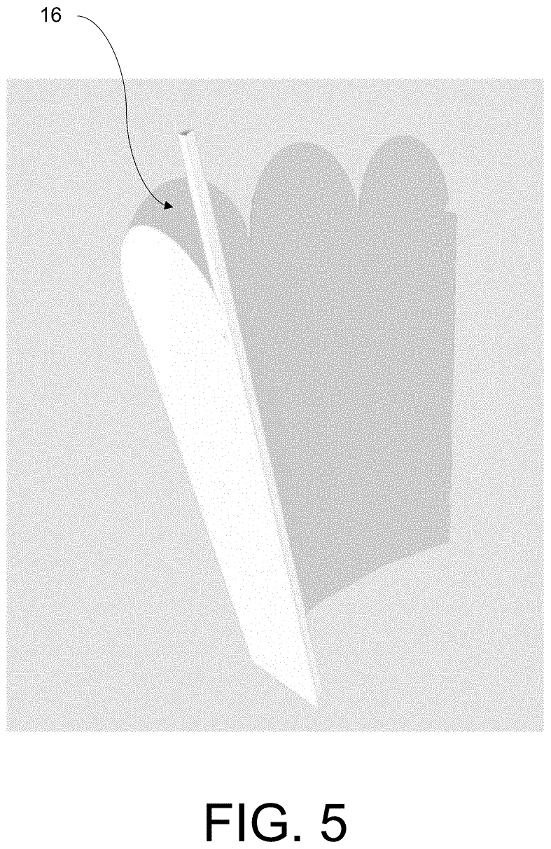

FIG. 6 is a simplified diagram showing a sidewall in a rolled state, according to some embodiments.

FIG. 7 is a simplified diagram showing a tab securing a sidewall, according to some embodiments.

FIG. 8 is a simplified diagram showing a base detached from a sidewall, according to some embodiments.

FIG. 9 is a simplified diagram showing a base attached to a sidewall, according to some embodiments.

FIG. 10 is a simplified diagram showing a plurality of closure panels transitioning between an open state and a closed state, according to some embodiments.

FIG. 11 is a simplified diagram showing a plurality of closure panels in a closed state, according to some embodiments.

### DETAILED DESCRIPTION

Certain embodiments provided by the present disclosure are directed to a container. More particularly, some embodiments provide a cup. Merely by way of example, some embodiments have been applied to a compostable cup. But it should be recognized that the subject matter provided by the present disclosure has a much broader range of applicability.

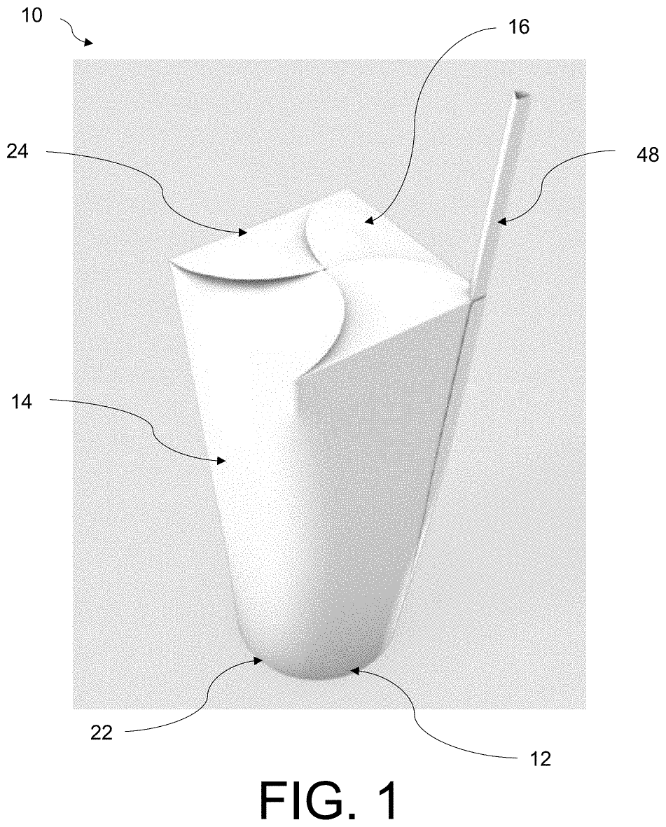

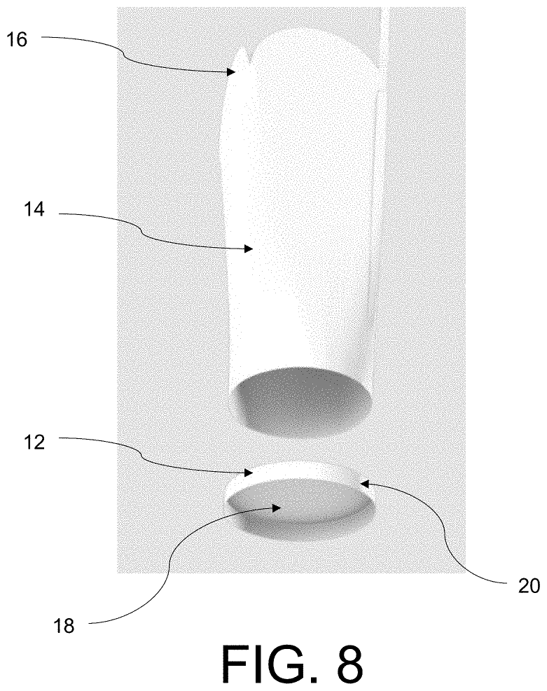

FIG. 1 is a simplified diagram showing a cup 10. This diagram is merely an example, which should not unduly limit the scope of the claims. One of ordinary skill in the art would recognize many variations, alternatives, and modifications. In various embodiments, the cup 10 is configured to receive and hold fluid and/or semi-solid solution. For example, the cup 10 is configured to receive and hold soft drinks. In certain examples, the cup 10 is biodegradable. In some examples, the cup 10 comprises paper coated with a liquid-repelling coating (e.g., bio-based polybutylene succinate), such as without any other material. In certain embodiments, the cup includes a base 12 (see FIG. 8 for another view), a sidewall 14, and a plurality of closure panels 16. Although the above has been shown using a selected group of components, there can be many alternatives, modifications, and variations. For example, some of the components may be expanded and/or combined. Other components may be inserted to or removed from those noted above. Depending upon the embodiment, the arrangement of components may be interchanged with others replaced.

In some embodiments, the base 12, as shown in FIG. 8, is substantially circular (e.g., less than 30%, 20%, 10%, or 5% deviation from a circle) and includes a bottom 18 that is substantially flat (e.g., less than 30%, 20%, 10%, or 5% deviation from a flat plane) and/or circular. In certain examples, the base 12 further includes a rim 20 disposed about the bottom 18, such as extending away from the bottom from the perimeter of the bottom. For example, the rim 20 extends, such as at a slight angle and configured to conform to the sidewall 14, towards a lower edge 22 of the cup when.

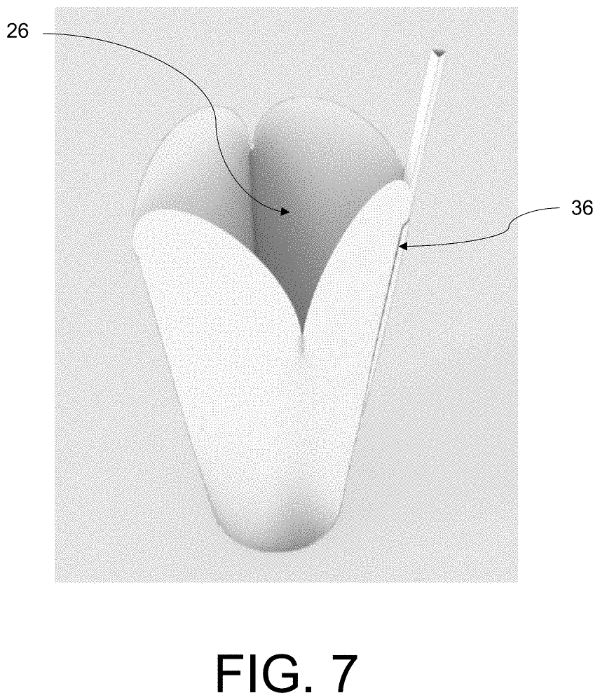

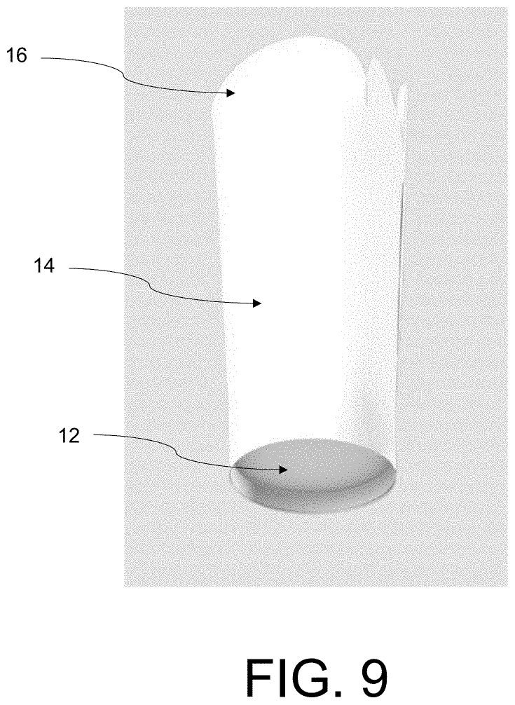

In some embodiments, the sidewall 14 forms the body of the cup and is configured to engage with a user's hand during use. In various examples, the sidewall 14 extends between an upper edge 24 of the cup 10 and the lower edge 22 of the cup, such as across the entire height of the cup. In some examples, the height of the cup 10 is defined as the height when the cup is in a closed position (e.g., as the cup shown in FIG. 1), such as when the plurality of closure panels 16 is closed. In certain examples, at the lower edge 22 of the cup 10, the sidewall 14 is coupled, such as attached (e.g., adhesively attached), to the base 12. For example, the sidewall 14 is coupled, such as continuously coupled, to the rim 20 of the base 12 at the lower edge 22 of the cup 10, as shown in FIG. 9. As an example, the sidewall 14 is conformally coupled to the rim 20 about the bottom 18 of the base 12, such as conformally coupled such that fluid is prevented from leaking out of the cup 10 from the lower edge 22 of the cup. In certain examples, the sidewall 14 and the base 12 define a content-receiving volume 26, as shown in FIG. 7. In some examples, the cup 10 is larger in size at the upper edge 24 than at the lower edge 22. For example, the sidewall is sloped from a smaller size (e.g., cross-sectional) at the lower edge 22 to a larger size (e.g., cross-sectional) at the upper edge 24. In some examples, the cup 10 is rectangular at the upper edge 24 and circular at the lower edge 22.

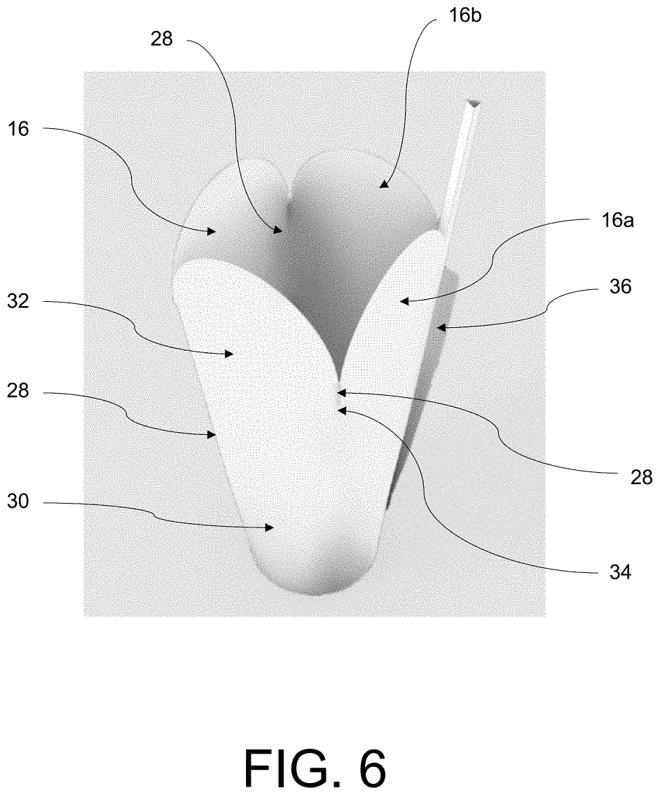

In certain examples, as shown in FIG. 6, the sidewall 14 has a plurality of side fold lines 28 connected to and extending from the upper edge 24 towards the lower edge 22. For example, the plurality of side fold lines 28 extends from the upper edge 24 towards the lower edge 22 by at least more than 5% of the height of the cup 10 and/or by at most 20% of the height of the cup. For example, the side fold lines extend by about a quarter inch. In various examples, the plurality of side fold lines 28 and the base 12 (e.g., the circular base) help divide the sidewall 14 into a lower portion 30 and an upper portion 32, such as divided at end points 34 of the fold lines 28 between the upper edge 24 and lower edge 22 of the cup 10. In some examples, the upper portion 32 is polygonal, such as having a polygonal cross-section having a number of corners equal to the number of side fold lines of the plurality of side fold lines 28 minus one and/or having a number of sides equal to the number of side fold lines of the plurality of side fold lines minus one. For example, for a rectangular upper portion, the plurality of side fold lines includes 5 side fold lines. In some examples, the lower portion 30 is circular, such as having a circular cross-section. In some examples, the plurality of side fold lines 28 includes four, five, six, eight, or ten side fold lines. In certain examples, the plurality of side fold lines 28 is uniformly distributed about the content-receiving volume 26.

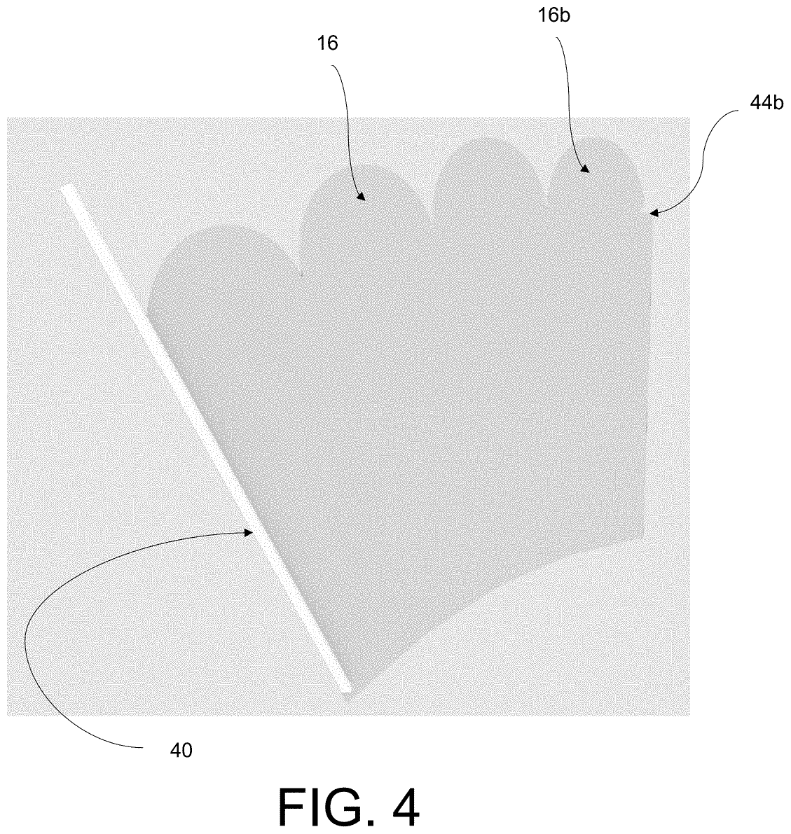

In certain embodiments, the cup 10 further includes a tab 36, as shown in FIG. 6 and FIG. 7, such as a securing tab, configured to secure the sidewall 14. For example, the tab 36 extends, such as integrally, from the sidewall 14, such as from a first end 38 of the sidewall 14. In some examples, the tab 36 spans a substantial portion of the height of the cup 10, such as more than 50%, 60%, 70%, 80%, or 90% of the height of the cup. In some examples, the tab 36 is configured to attach the first end 38 of the sidewall 14 to a second end 40 (see FIG. 4) of the sidewall. For example, when the tab 36 attaches, such as adhesively attaches the first end 38 and the second end 40 of the sidewall 14, the sidewall becomes circular at the lower portion.

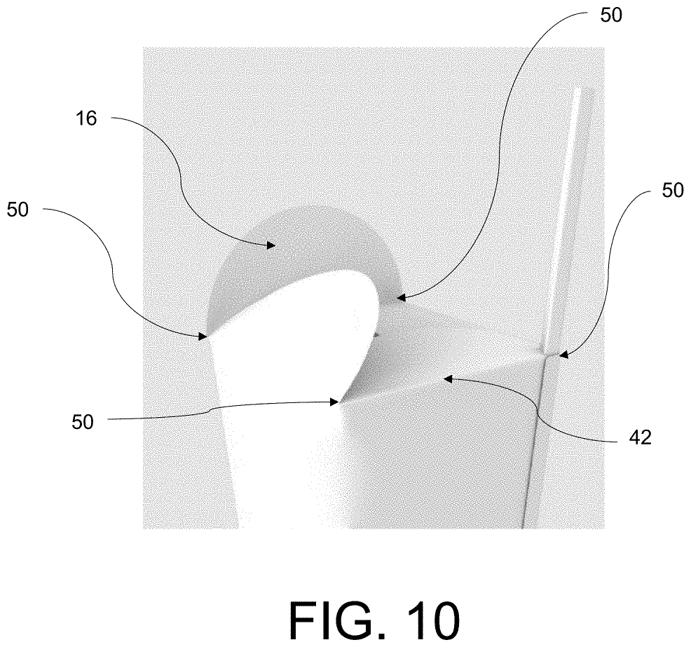

In some embodiments, the plurality of closure panels 16 extends, such as integrally (e.g., as a continuous part), from the sidewall at the upper edge of the cup (see FIG. 6). In various examples, the plurality of closure panels 16 extends from a plurality of top fold lines 42 (see FIG. 10) at the upper edge 24 of the cup 10. In certain examples, the top fold lines 42 are pre-formed. In some examples, each closure panel of the plurality of closure panels 16 is shaped as a segment of a circle, such as a semicircle. In certain examples, the plurality of closure panels 16 is configured to transition (e.g., via manipulation of a user) between a closed position (see FIG. 1) and an open position (see FIG. 7). In some examples, when in the closed position, the plurality of closure panels 16 substantially blocks (e.g., covering more than 60%, 70%, 80%, or 90% of a cup opening at the upper edge) content from entering the cup. For example, when in the closed position, the plurality of closure panels 16 overlaps with each other at least partially (see FIG. 10). In some examples, when in the open position, the plurality of closure panels 16 extends upwards (e.g., away from the base) substantially continuously from the sidewall 14. In certain examples, when in the closed position, each closure panel of the plurality of closure panels 16 lays on top of another closure panel of the plurality of closure panels, and that one closure panel of the plurality of closure panels is additionally tucked under another closure panel of the plurality of closure panels. For example, for a cup having four closure panels, a fourth closure panel may lay on top of a third closure panel and rucked under a first closure panel.

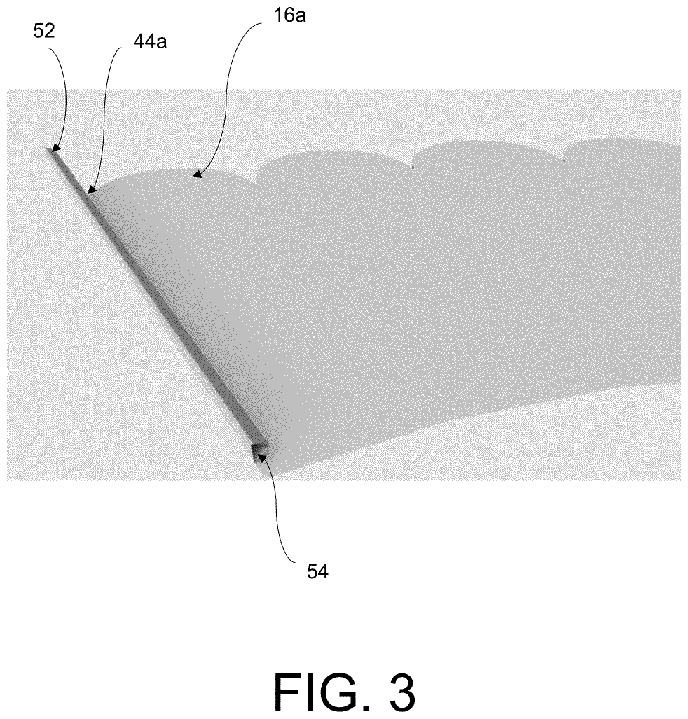

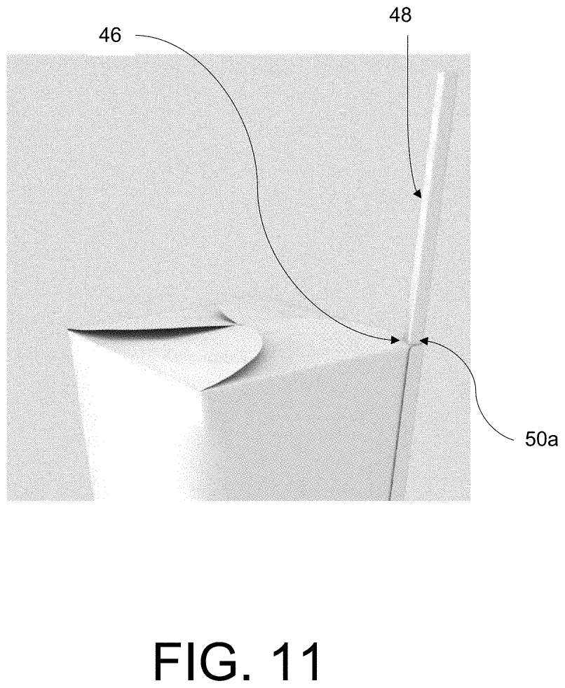

In certain examples, the plurality of closure panels 16 includes a number of closure panels equal to the number of side fold lines of the plurality of side fold lines 28 minus one. For example, if the plurality of side fold lines 28 includes five side fold lines, the plurality of closure panels 16 includes four closure panels. In various examples, the plurality of side fold lines 28 includes a first side fold line adjacent to a plurality of straw panels 56 and a second side fold line adjacent to a securing tab 36, which when assembled, the first side fold line and the second side fold line overlaps. In various examples, the plurality of closure panels 16 includes a first closure panel 16a (see FIG. 3) and a second closure panel 16b (see FIG. 4), a third closure panel, and/or a fourth closure panel. In certain examples, the first closure panel 16a includes a first cutout 44a (see FIG. 3) and the second closure panel 16b includes a second cutout 44b (see FIG. 4). In some examples, the first cutout 44a of the first closure panel 16a and the second cutout 44b of the second closure panel 14b are configured to define a straw receptacle 46 (see FIG. 11), such as when the plurality of closure panels 16 is in the closed position. In certain examples, the first cutout 44a and/or the second cutout 44b has a shape determined based on the shape of a straw 48 (see FIG. 11) to be received and/or held by the straw receptacle. For example, if the straw 48 to be received and/or held is triangular, then the first cutout 44a and/or the second cutout 44b has a triangular shape. In certain examples, the straw receptacle 46 is positioned at a first corner 50a (see FIG. 11) of a plurality of corners 50 (see FIG. 10) defined by the plurality of side fold lines 28 at the upper edge 24. In some examples, the cutouts are shaped as right-triangles.

In certain embodiments, the cup 10 further includes a straw 48, such as a straw extending integrally from the sidewall 14, such as from a second side 40 of the sidewall. In some examples, the straw 48 extends through the straw receptacle 46 at the upper edge 24 of the cup 10 and towards the lower edge 22 of the cup, such as by at least 70%, 80%, or 90% of the height of the cup (see FIG. 3). For example, the straw 48 has an upper end 52 and a lower end 54, the lower end being positioned above the base 12 and/or the lower edge 22 by less than 30% or 20% or 10% of the height of the cup 10. In various examples, the straw 48 has a triangular cross-section, such as a right-triangular cross-section, at least at the upper edge 24. In other examples, the straw 48 has another polygonal cross-section such as a square or a hexagon. In certain examples, the straw 48 is constructed from, as shown in FIG. 3, a plurality of straw panels 56 and a straw tab 58 (e.g., may be considered a straw panel of the plurality of straw panels) for securing the plurality of straw panels into the straw. In various examples, the straw 48 and/or the plurality of straw panels 56 (e.g., at least one straw panel of the plurality of straw panels) extend, such as integrally, from the second end 40 of the sidewall 14. In some examples, once constructed, the straw 48 is contained within the content-receiving volume 26 of the cup 10 and is configured to guide content, such as fluid, from the content-receiving volume to outside of the cup (e.g., into a user's mouth), such as when under suction.

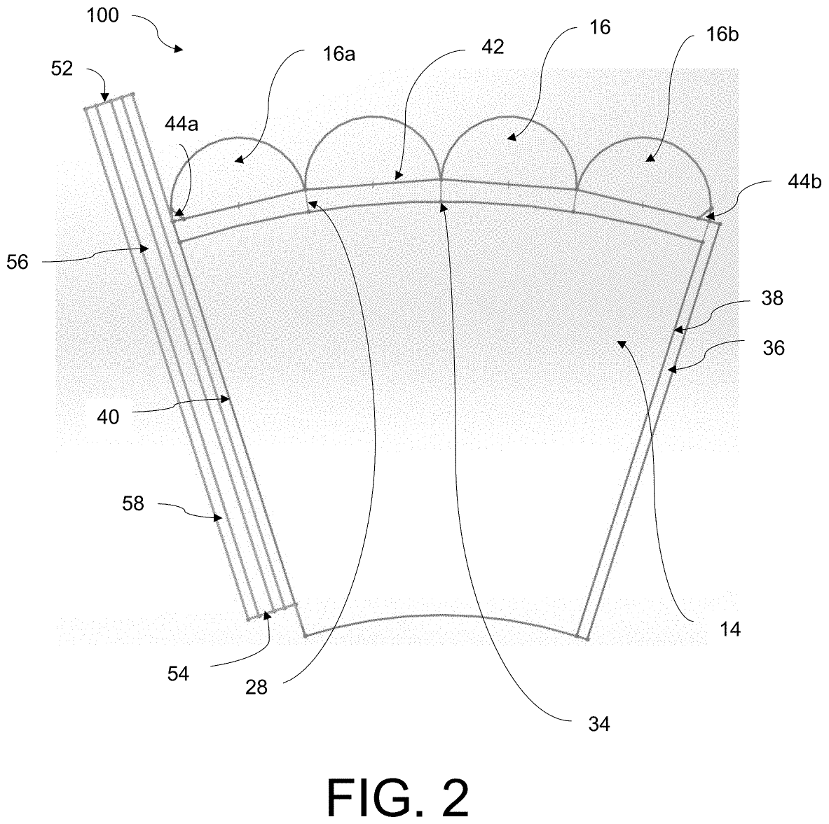

FIG. 2 is a simplified diagram showing a blank 100 for a cup, such as the cup 10 of FIG. 1. This diagram is merely an example, which should not unduly limit the scope of the claims. One of ordinary skill in the art would recognize many variations, alternatives, and modifications. In various examples, the blank 100 is substantially flat, such as having less than 20%, 10%, 5% deviation from being planar. In certain examples, the blank 100 is biodegradable. In some examples, the blank 100 comprises paper coated with a liquid-repelling coating (e.g., bio-based polybutylene succinate), such as without any other material. In certain embodiments, the blank 100 includes a sidewall 14 and a plurality of closure panels 16. Although the above has been shown using a selected group of components, there can be many alternatives, modifications, and variations. For example, some of the components may be expanded and/or combined. Other components may be inserted to or removed from those noted above. Depending upon the embodiment, the arrangement of components may be interchanged with others replaced.

In some embodiments, the sidewall 14 is configured to form a body of a cup. In various examples, the sidewall 14 is configured to extend between an upper edge of the cup and a lower edge of the cup, such as across the entire height of the cup. In some examples, the height of the cup is defined as the height when the cup is in a closed position. In certain examples, the sidewall 14 is configured to be coupled to a base. In certain examples, when the blank 100 is constructed into a cup, the sidewall 14 and the base define a content-receiving volume. In some examples, when blank 100 is constructed into a cup, the sidewall 14 is narrower at the lower edge and wider at the upper edge. In certain examples, the sidewall 14 has a plurality of side fold lines 28 that, when blank 100 is constructed into a cup, extends from the upper edge towards the lower edge. For example, the plurality of side fold lines 28, when blank 100 is constructed into a cup, extends from the upper edge towards the lower edge by at least more than 5% of the height of the cup and/or by at most 20% of the height of the cup. In various examples, the plurality of side fold lines 28 helps divide the sidewall 14 into a lower portion 30 and an upper portion 32, such as divided at end points 34 of the fold lines 28. In some examples, the plurality of side fold lines 28 includes four, five, six, eight, or ten side fold lines.

In certain embodiments, the blank 100 further includes a tab 36, such as a securing tab, configured to secure the sidewall 14. For example, the tab 36 extends, such as integrally, from the sidewall 14, such as from a first end 38 of the sidewall. In some examples, the tab 36 spans a substantial portion of the height of the would-be-constructed cup, such as more than 50%, 60%, 70%, 80%, or 90% of the height of the cup. In some examples, the tab 36 is configured to attach the first end 38 of the sidewall 14 to a second end 40 of the sidewall. For example, when the tab 36 attaches, such as adhesively attaches the first end 38 and the second end 40 of the sidewall 14, the sidewall is configured to become circular at the lower portion.

In some embodiments, the plurality of closure panels 16 extends, such as integrally (e.g., as a continuous part), from the sidewall 14. In various examples, the plurality of closure panels 16 extends from a plurality of top fold lines 42. In some examples, each closure panel of the plurality of closure panels 16 is shaped as a segment of a circle, such as a semicircle. In certain examples, the plurality of closure panels 16 includes a number of closure panels equal to the number of side fold lines of the plurality of side fold lines 28 minus one. For example, if the plurality of side fold lines 28 includes five side fold lines, the plurality of closure panels 16 includes four fold closure panels. In various examples, the plurality of closure panels 16 includes a first closure panel 16a and a second closure panel 16b, a third closure panel, and a fourth closure panel. In certain examples, the first closure panel 16a includes a first cutout 44a and the second closure panel 16b includes a second cutout 44b. In some examples, the first cutout 44a of the first closure panel 16a and the second cutout 44b of the second closure panel 16b are configured to define a straw receptacle, such as when the plurality of closure panels 16 is in the closed position. In certain examples, the first cutout 44a and/or the second cutout 44b has a shape determined based on the shape of the straw to be received and/or held by the straw receptacle. For example, if the straw to be received and/or held is triangular, then the first cutout 44a and/or the second cutout 44b has a triangular shape. In certain examples, the cutouts are configured to define the straw receptacle at a first corner of a plurality of corners defined by the plurality of side fold lines 28 at the upper edge.

In certain embodiments, the blank 100 further includes a plurality of straw panels 56 configured to form a straw connected to and extending from the sidewall. In certain examples, the straw is constructed from a plurality of straw panels 56 and a straw tab 58 (e.g., as a straw panel of the plurality of straw panels) for securing the plurality of straw panels into the straw. In various examples, the plurality of straw panels 56 extends, such as integrally, from the second end 40 of the sidewall 14. In some examples, the plurality of straw panels 56 extends from above the first and the second cutoffs defining the straw receptacle at the upper edge and towards the lower edge of the cup, such as by at least 70%, 80%, or 90% of the height of the cup. For example, the plurality of straw panels 56 has an upper end 52 and a lower end 54, the lower end being positioned above the lower edge by less than 30% or 20% or 10% of the height of the cup. In various examples, the plurality of straw panels 56, when constructed into a straw, forms a triangular cross-section, such as a right-triangular cross-section, at least at the upper edge. In other examples, the plurality of straw panels 56, when constructed into a straw, forms another polygonal cross-section such as a square or a hexagon.

In some embodiments, a method for forming a cup (e.g., the cup 10 of FIG. 1) from a blank (e.g., the blank 100 of FIG. 2) includes rolling the plurality of straw panels (e.g., plurality of straw panels 56) into a straw (e.g., straw 48) having a triangular cross-section and connected to and extending from beyond an upper edge (e.g., upper edge 24) towards a lower edge (e.g., lower edge 22) by at least 80% of the height of the cup; folding a sidewall (e.g., sidewall 14) along a plurality of side fold lines (e.g., side fold lines 28) of the sidewall; rolling the sidewall to couple a base (e.g., base 12) to the sidewall at the lower edge to define a content-receiving volume (e.g., content-receiving volume 26); and attaching a first end (e.g., first end 38) of the sidewall with a second end (e.g., second end 40) of the sidewall by affixing a tab (e.g., tab 36) attached to the first end of the sidewall to the second end of the sidewall. In certain examples, rolling the sidewall includes positioning the straw at a corner (e.g., corner 50a) along a fold line of the plurality of side fold lines of the sidewall. Although the above has been shown using a selected group of processes for the method, there can be many alternatives, modifications, and variations. For example, some of the processes may be expanded and/or combined. Other processes may be inserted to or removed from those noted above. Depending upon the embodiment, the sequence of processes may be interchanged with others replaced.

Although specific embodiments have been described, it will be understood by those of skill in the art that there are other embodiments that are equivalent to the described embodiments. Accordingly, it is to be understood that the disclosed subject matter is not to be limited by the specific illustrated embodiments.

What is claimed is:

1. A cup comprising:
a base having a circular bottom and a rim coupled to a perimeter of the bottom;
a sidewall extending upwards from the base between an upper edge and a lower edge, the sidewall being continuously coupled to the rim at the lower edge;
a plurality of closure panels integrally connected to and extending from the sidewall at the upper edge, the plurality of closure panels includes a first closure panel having a first cutout and a second closure panel having a second cutout;
a straw connected to and extending from a second end of the sidewall and extending upwards from near the lower edge to beyond the upper edge; and
a tab connected to and extending from a first end of the sidewall and attaching the first end of the sidewall to a second end of the sidewall;
wherein:
the plurality of closure panels is configured to be foldable between a closed position and an open position;
when the plurality of closure panels is in the closed position:
the first cutout and the second cutout overlap to define a straw receptacle configured to receive the straw, and
the straw extends through the straw receptacle;
the sidewall has a plurality of side fold lines connected to and extending from the upper edge towards the lower edge;
the sidewall and the base define a content-receiving volume; and
the cup is biodegradable.

2. The cup of claim 1, wherein the plurality of side fold lines extends from the upper edge towards the lower edge by at least 5% of the height of the cup.

3. The cup of claim 1, wherein the plurality of side fold lines extends from the upper edge towards the lower edge by at most 20% of the height of the cup.

4. The cup of claim 1, wherein the plurality of side fold lines is uniformly distributed about the content-receiving volume.

5. The cup of claim 1, wherein the cup has five side fold lines.

6. The cup of claim 1, wherein the plurality of closure panels includes a number of closure panels and the plurality of side fold lines includes a number of side fold lines, the number of closure panels equals to the number of side fold lines minus one.

7. The cup of claim 1, wherein each closure panel of the plurality of closure panels is a segment of a circle.

8. The cup of claim 1, wherein each closure panel of the plurality of closure panels is a semicircle.

9. The cup of claim 1, wherein the cup is larger in size at the upper edge than at the lower edge.

10. The cup of claim 1, wherein the straw receptacle is positioned at a first corner of a plurality of corners defined by the plurality of side fold lines at the upper edge.

11. The cup of claim 1, wherein the straw has a triangular cross-section at least at the upper edge.

12. The cup of claim 1, wherein the straw has a right-triangular cross-section at least at the upper edge.

13. The cup of claim 1, wherein the plurality of closure panels integrally extends from a plurality of top fold lines.

14. The cup of claim 1, wherein the cup comprises paper coated with a liquid-repelling coating.

15. The cup of claim 14, wherein the liquid-repelling coating is bio-based polybutylene succinate.

16. A blank for a cup, comprising:
a sidewall extending between an upper edge and a lower edge;
a plurality of closure panels integrally connected to and extending from the sidewall at the upper edge, the plurality of closure panels includes a first closure panel having a first cutout and a second closure panel having a second cutout;
a plurality of straw panels connected to and extending from the sidewall from a second end of the sidewall, the plurality of straw panels configured to form a straw connected to and extending from the second end of the sidewall; and
a tab connected to and extending from a first end of the sidewall and configured to attach the first end of the sidewall to the second end of the sidewall during cup assembly;
wherein:
the plurality of closure panels is configured to be foldable between a closed position and an open position;
when the plurality of closure panels is in the closed position:
the first cutout and the second cutout overlap to define a straw receptacle configured to receive the straw, and
the straw extends through the straw receptacle;
the sidewall has a plurality of side fold lines connected to and extending from the upper edge towards the lower edge; and
the blank is biodegradable.

17. The blank of claim 16, wherein the plurality of side fold lines extends from the upper edge towards the lower edge by at least 5% of the height of the cup.

18. The blank of claim 16, wherein the plurality of side fold lines extends from the upper edge towards the lower edge by at most 20% of the height of the cup.

19. The blank of claim 16, wherein each closure panel of the plurality of closure panels is a segment of a circle.

20. A method for forming a cup from a blank including a sidewall, a plurality of closure panels, and a plurality of straw panels, comprising:
rolling a plurality of straw panels of the blank into a straw having a triangular cross-section and connected to and extending from an upper edge of the cup towards a lower edge of the cup by at least 80% of the height of the cup;
folding a sidewall of the blank along a plurality of side fold lines of the sidewall;
rolling the sidewall to couple a base to the sidewall at the lower edge to define a content-receiving volume; and
attaching a first end of the sidewall with a second end of the sidewall by affixing a tab connected to and extending from the first end of the sidewall to the second end of the sidewall;
wherein rolling the sidewall includes positioning the straw at a corner along a side fold line of the plurality of side fold lines of the sidewall.
